(19) United States
(12) Patent Application Publication
(10) Pub. No.: US 2012/0114157 A1
(43) Pub. Date: May 10, 2012

(54) METHOD AND HEARING AID FOR DETERMINING MOISTURE AND COMPUTER PROGRAM PRODUCT IMPLEMENTING THE METHOD

(75) Inventors: Georg-Erwin Arndt, Obermichelbach (DE); Hartmut Ritter, Neunkirchen Am Brand (DE); Meike Steinbuss, Erlangen (DE); Tom Weidner, Erlangen (DE)

(73) Assignee: SIEMENS MEDICAL INSTRUMENTS PTE. LTD., Singapore (SG)

(21) Appl. No.: 13/289,186

(22) Filed: Nov. 4, 2011

(30) Foreign Application Priority Data
Nov. 4, 2010 (DE) 10 2010 043 413.2

(51) Int. Cl. H04R 25/00

(52) U.S. Cl. 381/315

(57) ABSTRACT

A method for determining moisture on a covering of a microphone opening of a hearing aid housing without additional components includes determination of an acoustic parameter originating from an earpiece in a microphone signal of a microphone disposed below the covering, comparison of the determined acoustic parameter with a reference parameter characteristic of moisture on the covering, and emission of a moisture signal if the determined acoustic parameter lies within a predefinable tolerance range of the reference parameter. An associated hearing aid and a computer program product for implementing the method, are also provided.

### CROSS-REFERENCE TO RELATED APPLICATION

This application claims the priority, under 35 U.S.C. §119, of German Patent Application DE 10 2010 043 413.2, filed Nov. 4, 2010; the prior application is herewith incorporated by reference in its entirety.

### BACKGROUND OF THE INVENTION

### Field of the Invention

The invention relates to a method and a hearing aid for determining moisture on a covering of a microphone opening of a hearing aid housing. The invention also relates to a computer program product for implementing the method.

In principle, the important components of hearing aids are an input converter, an amplifier and an output converter. The input converter is generally a receiving transducer, e.g. a microphone, and/or an electromagnetic earpiece, e.g. an inductance coil. The output converter is usually implemented as an electroacoustic converter, e.g. a miniature loudspeaker, or as an electromechanical converter, e.g. a bone conduction earpiece. The amplifier is normally integrated into a signal processing unit. The principle of that structure is illustrated in FIG. 1 using the example of a behind-the-ear hearing aid 1. A hearing aid housing 2 for wearing behind the ear normally incorporates two microphones 3 for receiving ambient sound. Microphone openings 7 are formed above the microphones 3 in the hearing aid housing 2. Due to the sound openings 7, the sound can penetrate to the microphones 3 in the interior of the hearing aid housing. A signal processing unit 4, which is likewise integrated into the hearing aid housing 2, processes the microphone signals and amplifies them. An output signal from the signal processing unit 4 is transmitted to a loudspeaker or earpiece 5, which emits an acoustic signal. Where appropriate, the sound is transmitted to the eardrum of the hearing aid wearer through a non-illustrated sound tube, which is fixed in the auditory canal with an otoplastic. The energy supply for the hearing aid 1 and, in particular, for the signal processing unit 4, is provided by a battery 6 which is likewise integrated into the hearing aid housing 2.

In order to protect the microphones 3 of the hearing aid 1 against liquids and pollution, the microphone openings 7 are normally covered by a watertight membrane. German Patent DE 10 2005 012 149 B3, corresponding to U.S. Pat. No. 7,676,050, discloses a cover device for a microphone input of a hearing aid with an acoustically permeable protective device to protect the microphone input against particles of solid matter. The cover device in that case is fixed to the surface of the hearing aid and the protective device can, for example, be constructed as a watertight membrane.

If acoustic couplings exist in a hearing aid between a microphone and an earpiece, feedback effects, for example “whistling,” can occur. FIG. 2 schematically shows a hearing aid 1 with an acoustic feedback. The hearing aid 1 is located in an acoustic environment. A signal 11 received by a microphone 3 of the hearing aid 1 is, inter alia, amplified in a signal processing unit 4 and is emitted again through an earpiece 5 of the hearing aid 1. An acoustic coupling from the earpiece 5 back to the microphone 3 occurs through a physical feedback path 12. The signal 11 which is received is thus formed of the total of an incident wanted signal 10 and the signal fed through the feedback path 12. As a consequence of the feedback, feedback whistling occurs if both the amplitude condition and the phase condition are met. In contrast, noise artifacts occur even if those conditions are only approximately met.

### SUMMARY OF THE INVENTION

It is accordingly an object of the invention to provide a method and a hearing aid for determining moisture and a computer program product for implementing the method, which overcome the hereinafore-mentioned disadvantages of the heretofore-known methods, hearing aids and programs of this general type and which can determine moisture on a microphone cover.

With the foregoing and other objects in view there is provided, in accordance with the invention, a method for determining moisture on a covering which closes or covers a microphone opening of a hearing aid housing and is permeable to sound, but prevents penetration of dampness. The method comprises determining an acoustic parameter originating from an earpiece, for example an acoustic feedback, in a microphone signal of a microphone disposed below the covering, a comparison of the determined acoustic parameter with a reference parameter characteristic of moisture on the covering, for example a reference feedback, or with an average value of the acoustic parameters determined in past periods and an emission of a moisture signal, if the determined acoustic parameter lies within a predefinable tolerance range of the reference parameter or if the determined acoustic parameter exceeds a defined window of permitted deviations from the average value of the acoustic parameters determined in past periods. If the acoustic parameter lies outside permitted deviations from the average value, this also indicates moisture. A relative change in the acoustic parameter can also thus be detected and evaluated for moisture, since a reference parameter does not always exist. The invention offers the advantage that moisture on a covering can be determined without additional components.

In accordance with another mode of the invention, the acoustic parameter can be determined in a frequency range between 600 Hz and 1600 Hz. In this range, the change, for example in the feedback, is in particular characteristic of moisture.

In accordance with a further mode of the invention, the determination of the acoustic parameter can be effected by a hearing aid.

In accordance with an added mode of the invention, the reference parameter can be determined beforehand through the use of trials.

In accordance with an additional mode of the invention, the reference parameter can be stored in the hearing aid.

With the objects of the invention in view, there is also provided a hearing aid, comprising a hearing aid housing with at least one microphone opening, an earpiece which emits sound, a microphone disposed under the microphone opening and a covering on the microphone opening. The hearing aid furthermore includes a feedback recognition unit, which determines an acoustic feedback originating from the earpiece in a microphone signal of the microphone, a comparison unit which compares the determined feedback with a reference feedback characteristic of moisture on the covering or which compares the determined feedback with an average value of the feedbacks determined in past periods (historic feedback), and a signal generation unit which generates a moisture signal if the determined feedback lies within a predefinable tolerance range of the reference feedback or if the determined feedback exceeds a defined window of permitted deviations from the average value of the feedbacks determined in past periods.

Instead of the acoustic feedback, another acoustic parameter and an associated acoustic reference parameter can also be used.

In accordance with another feature of the invention, the hearing aid can include a storage unit, in which the reference feedback or the reference parameter are stored.

In accordance with a further feature of the invention, the covering can be watertight.

In accordance with an added feature of the invention, a membrane permeable to sound can be integrated into the covering.

With the objects of the invention in view, there is concomitantly provided a computer program product with a computer program which has software for implementing the method according to the invention, if the computer program is run in a signal processing unit of the hearing aid.

Other features which are considered as characteristic for the invention are set forth in the appended claims.

Although the invention is illustrated and described herein as embodied in a method and a hearing aid for determining moisture and a computer program product for implementing the method, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, longitudinal-sectional view of a behind-the-ear hearing aid according to the prior art;

FIG. 2 is a block diagram of an acoustic feedback in a hearing aid;

FIG. 3 is a graph illustrating an OLG measurement without moisture;

FIG. 4 is a graph illustrating an OLG measurement with moisture;

FIG. 5 is a flowchart of a method for determining moisture on a cover membrane; and

FIG. 6 is a longitudinal-sectional view of a hearing aid with feedback recognition for determining moisture.

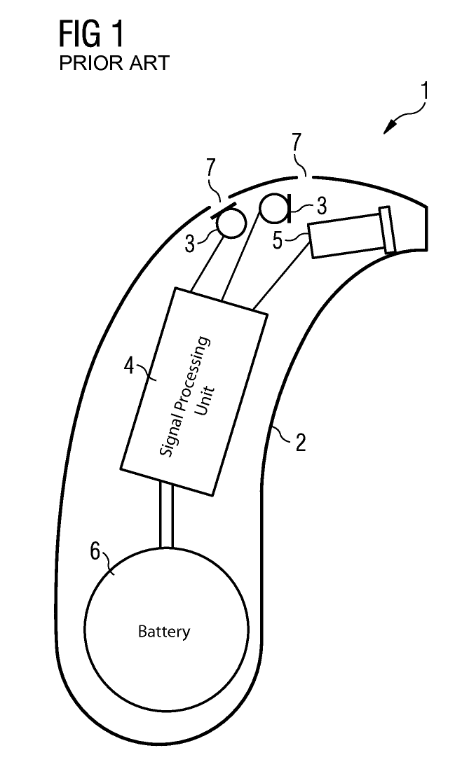

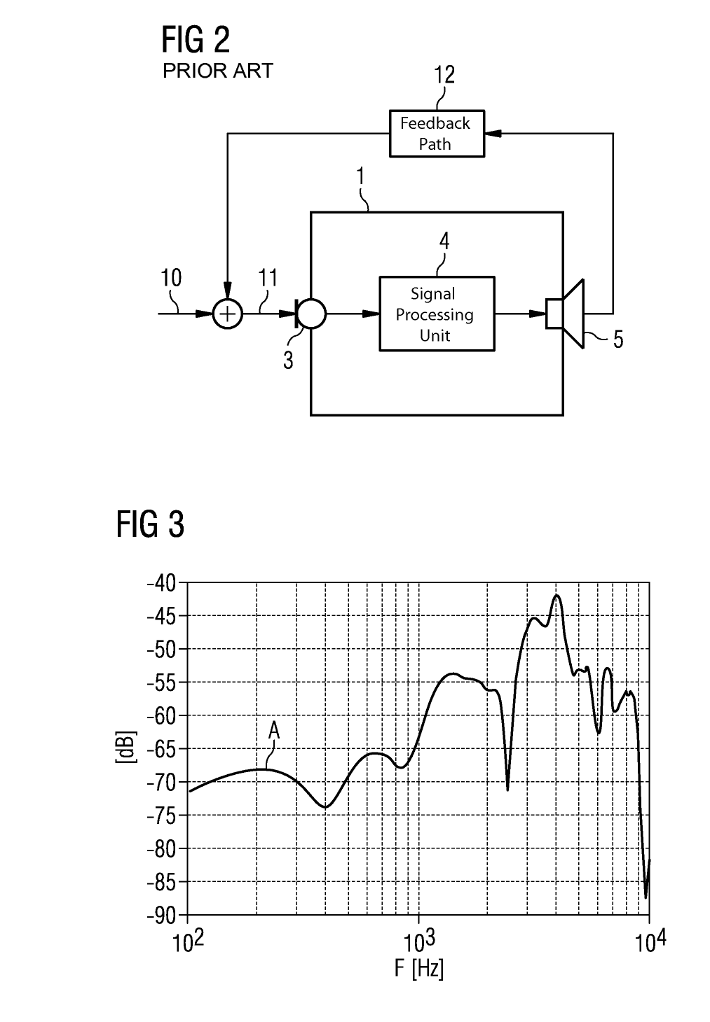

### DETAILED DESCRIPTION OF THE INVENTION

Referring now to the figures of the drawings in detail, it will be seen that the invention is described in greater detail below using the example of a “feedback” acoustic parameter. A method for determining feedback in hearing aids includes measuring an open loop gain (OLG), with a signal path of a hearing aid being split by respective switches upstream and downstream of a signal processing unit. Test tones of different frequencies or audible noises are generated in a tone generator of the hearing aid, emitted through an earpiece and received by a microphone over a feedback path. The level of the received, fed-back signal is determined upstream of the first switch using a level meter. The difference from the original level of the test tones or of the audible noise represents the OLG, which is a measure of the feedback.

FIG. 3 shows the result of such an OLG measurement in a behind-the-ear hearing aid with a microphone opening in its hearing aid housing. The microphone opening is closed with a covering. The covering includes a sound-permeable, watertight membrane. A first transmission function A of the illustrated OLG measurement shows the frequency response of a fed-back signal through a frequency F in Hz. The transmission function A indicates how strongly a test signal emitted by an earpiece is received, attenuated by a microphone. At 1000 Hz the attenuation is approximately 60 dB.

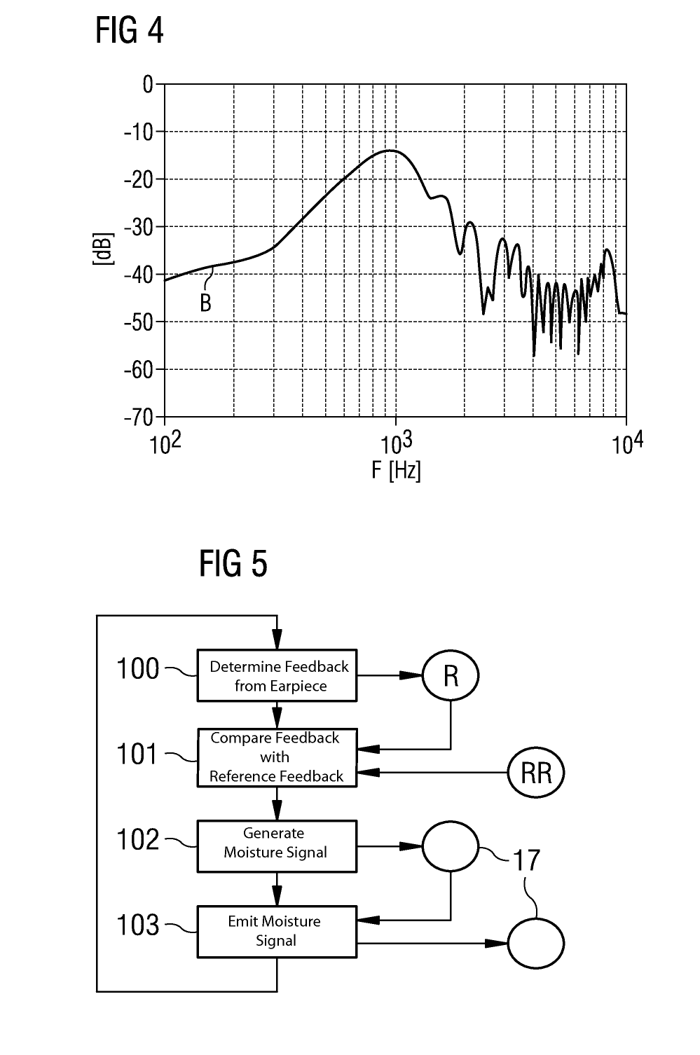

FIG. 4 now shows the same OLG measurement, but with a water-covered membrane. This means that the membrane is wet. A second transmission function B is illustrated as a function of the frequency F. It can clearly be seen that the attenuation is significantly less. At 1000 Hz it is only 15 dB. Particularly in the 600 Hz to 1600 Hz range there is a significant increase in feedback. This surprising finding is utilized by the invention.

FIG. 5 illustrates a flowchart of a method according to the invention for determining moisture on a sound-permeable membrane. The membrane is part of a covering which closes a microphone opening in a hearing aid housing. Below the microphone opening is a microphone. The microphone receives ambient noise, including sound fed back from an earpiece. In a step 100, an acoustic feedback R originating from the earpiece is determined in the microphone signal of the microphone. The determined feedback R is then compared in a step 101 with a reference feedback RR.

The reference feedback RR is characteristic of moisture on the membrane. If the determined feedback R lies within a predefinable tolerance range of the reference feedback RR, a moisture signal 17 is generated in a step 102 and in a step 103 it is, for example, emitted for signal processing. The moisture signal 17 can, for example, be used to switch to a different hearing aid program or to emit a warning signal.

The reference feedback RR is determined by trials beforehand with a comparable hearing aid.

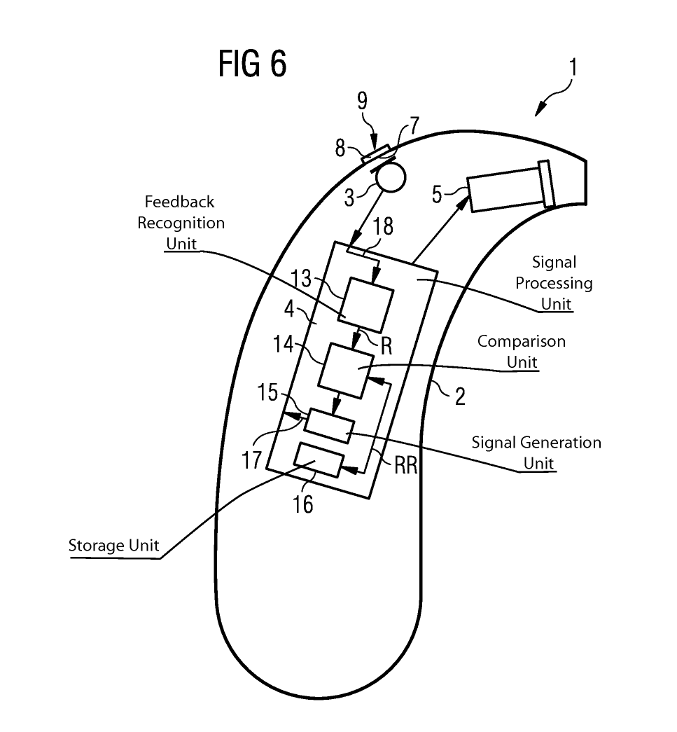

FIG. 6 shows components, which are important to the invention, of a behind-the-ear hearing aid 1. A microphone 3 for receiving ambient sound is incorporated into a hearing aid housing 2 for wearing behind the ear. The hearing aid housing 2 is constructed to have a microphone opening 7 above the microphone 3. The sound can penetrate to the microphone 3 in the interior of the hearing aid housing 2 through this opening 7. A signal processing unit 4, which likewise is disposed in the hearing aid housing 2, processes and amplifies an electrical microphone signal 18 emitted by the microphone 3. An output signal from the signal processing unit 4 is transmitted to a loudspeaker or earpiece 5, which emits an acoustic signal. Where appropriate, the sound generated in this way is transmitted to the eardrum of the hearing aid wearer through a non-illustrated sound tube, which is fixed in the auditory canal with an otoplastic.

In order to protect the microphone 3 of the hearing aid 1 against liquids and pollution, the microphone opening 7 is closed with a watertight membrane 9, which is part of a covering 8.

The microphone signal 18 is fed to a feedback recognition unit 13. This unit 13 determines a feedback R in the microphone signal 18, which is caused by an acoustic sound transmission from the earpiece 5 to the microphone 3. The determined feedback R is compared in a comparison unit 14 with a reference feedback RR (see FIG. 4) that is typical of moisture on the membrane 9. If the determined feedback R lies within a tolerance range of the reference feedback RR a moisture signal 17 is generated and emitted in a signal generation unit 15. This can be used to control the hearing aid 1 or to change hearing aid parameters. The reference feedback RR determined by trials beforehand is stored in a storage unit 16, which the comparison unit 14 can access.

The feedback recognition unit 13, the comparison unit 14, the signal generation unit 15 and the storage unit 16 can be constructed as part of the signal processing unit 4 or as separate units.

1. A method for determining moisture on a covering of a microphone opening of a hearing aid housing, the method comprising the following steps:
determining an acoustic parameter originating from an earpiece in a microphone signal of a microphone disposed below the covering;
comparing the determined acoustic parameter with a reference parameter characteristic of moisture on the covering or with an average value of acoustic parameters determined in past periods; and
emitting a moisture signal if the determined acoustic parameter lies within a predefinable tolerance range of the reference parameter or if the determined acoustic parameter exceeds a predefinable window of permitted deviations from an average value of the acoustic parameters determined in past periods.

2. The method according to claim 1, which further comprises determining the acoustic parameter in a frequency range between 600 Hz and 1600 Hz.

3. The method according to claim 1, wherein the step of determining the acoustic parameter is effected by a hearing aid.

4. The method according to claim 1, which further comprises determining the reference parameter beforehand by trials.

5. The method according to claim 3, which further comprises storing the reference parameter in the hearing aid.

6. The method according to claim 4, which further comprises storing the reference parameter in the hearing aid.

7. A method for determining moisture on a covering of a microphone opening of a hearing aid housing, the method comprising the following steps:
determining an acoustic feedback originating from an earpiece in a microphone signal of a microphone disposed below the covering;
comparing the determined feedback with a reference feedback characteristic of moisture on the covering or with an average value of feedbacks determined in past periods; and
emitting a moisture signal if the determined feedback lies within a predefinable tolerance range of the reference feedback or if the determined feedback exceeds a predefinable window of permitted deviations from an average value of the feedbacks determined in past periods.

8. The method according to claim 7, which further comprises determining the acoustic parameter in a frequency range between 600 Hz and 1600 Hz.

9. The method according to claim 7, wherein the step of determining the acoustic parameter is effected by a hearing aid.

10. The method according to claim 7, which further comprises determining the reference parameter beforehand by trials.

11. The method according to claim 9, which further comprises storing the reference parameter in the hearing aid.

12. The method according to claim 10, which further comprises storing the reference parameter in the hearing aid.

13. A hearing aid, comprising:
a hearing aid housing with at least one microphone opening;
an earpiece emitting sound;
at least one microphone disposed below said microphone opening and emitting a microphone signal;
at least one covering on said microphone opening;
a recognition unit connected to said at least one microphone for determining an acoustic parameter originating from said earpiece in the microphone signal;
a comparison unit connected to said recognition unit for comparing the determined acoustic parameter with a reference parameter characteristic of moisture on said at least one covering or for comparing the determined acoustic parameter with an average value of acoustic parameters determined in past periods; and
a signal generation unit connected to said comparison unit for generating a moisture signal if the determined acoustic parameter lies within a predefinable tolerance range of the reference parameter or if the determined acoustic parameter exceeds a predefinable window of permitted deviations from the average value of the acoustic parameters determined in past periods.

14. The hearing aid according to claim 13, wherein:
said feedback recognition unit determines an acoustic feedback originating from said earpiece in the microphone signal of said at least one microphone;
said comparison unit compares the determined feedback with a reference feedback characteristic of moisture on said covering or compares the determined feedback with an average value of feedbacks determined in past periods; and
said signal generation unit generates the moisture signal if the determined feedback lies within a predefinable tolerance range of the reference feedback or if the determined feedback exceeds a predefinable window of permitted deviations from the average value of the feedbacks determined in past periods.

15. The hearing aid according to claim 13, which further comprises a storage unit in which the reference parameter is stored.

16. The hearing aid according to claim 13, wherein said covering is watertight.

17. The hearing aid according to claim 13, which further comprises a sound-permeable membrane in said covering.

18. A computer software product stored on a memory executable by a signal processing unit of a hearing aid to perform the steps of claim 1.
